(19) United States
(12) Patent Application Publication
(10) Pub. No.: US 2025/0244950 A1
(43) Pub. Date: Jul. 31, 2025

(54) SHUFFLE EXCHANGE NETWORK TO GENERATE FULL SET OF PERMUTATIONS

(71) Applicant: QUALCOMM Incorporated, San Diego, CA (US)

(72) Inventors: Mithil RAMTEKE, Bangalore (IN); Sridhar KANDIMALLA, Bengaluru (IN)

(21) Appl. No.: 18/428,826

(22) Filed: Jan. 31, 2024

(51) Int. Cl. G06F 7/08

(52) U.S. Cl. CPC G06F 7/08; G06F 7/766

(57) ABSTRACT

A shuffle exchange network includes a first circuit that includes a first stage having a first set of elements storing a first set of sequences of length N, and multiple exchange units each receiving input from a first pair of the elements. Each exchange unit selectively couples the first pair of elements in the first stage to a second pair of elements that is fed back to the first stage. The exchange units receive input from each pair of elements based on a perfect shuffle operation. A second circuit outputs to the first circuit and includes a second stage preceding the first stage. The second circuit operates based on an inverse perfect shuffle operation.

### BACKGROUND

### Field

Aspects of the present disclosure relate to computing devices, and more specifically to a processor implementing a shuffle exchange network to generate a full set of permutations.

### Background

Computing devices include mobile phones, laptops, palmtop and tablet computers, portable digital assistants (PDAs), portable game consoles, and other portable electronic devices. Computing devices may also be deployed in robotic devices and automobiles, for example, to implement self-navigation. Connected home devices also include computing devices. Computing devices are comprised of many electrical components, such as system-on-a-chip (SoC) devices, graphics processing unit (GPU) devices, neural processing unit (NPU) devices, digital signal processors (DSPs), and modems, among others.

Neural network processing may be performed with any of these computing devices, for example, to detect objects. When detecting objects, it may be desirable to rank the detected objects by employing sorting techniques. Existing sorting techniques, however, may become a performance bottleneck. Processors of computing devices may also perform permutation operations other than sorting. For example, parallel processing techniques may be employed for dynamically accessing memory, polynomial evaluations, etc. It would be desirable to improve the processing speed for performing these types of permutations.

### SUMMARY

In aspects of the present disclosure, a shuffle exchange network includes a first circuit that includes a first stage that has a set of elements storing a set of sequences of length N, and a set of exchange units each receiving input from a first pair of the elements. Each of the exchange units selectively couples the first pair of elements in the first stage to a second pair of elements that is fed back to the first stage. The exchange units receive input from each pair of the elements based on a perfect shuffle operation.

In other aspects of the present disclosure, a processor-implemented method, includes performing a first series of inverse shuffle operations on an input sequence to generate an intermediate sequence. The method also includes performing a second series of shuffle operations on the intermediate sequence to generate an output sequence that is a specified permutation of the input sequence.

Other aspects of the present disclosure are related to an apparatus. The apparatus includes means for performing a first series of inverse shuffle operations on an input sequence to generate an intermediate sequence. The apparatus also includes means for performing a second series of shuffle operations on the intermediate sequence to generate an output sequence that is a specified permutation of the input sequence.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a processor for executing a shuffle exchange network, in accordance with various aspects of the present disclosure.

FIG. 2 is a block diagram illustrating an example of a perfect shuffle operation, in accordance with various aspects of the present disclosure.

FIG. 3 is a block diagram illustrating an example of an exchange unit, in accordance with various aspects of the present disclosure.

FIG. 4A is a block diagram illustrating an example of a perfect shuffle exchange network, in accordance with various aspects of the present disclosure.

FIG. 4B is a block diagram illustrating an example of an inverse perfect shuffle exchange network, in accordance with various aspects of the present disclosure.

FIG. 5 is a block diagram illustrating an example of a Benes network.

FIG. 6 is a table illustrating a Benes sequence comparison to a sequence of inverse and regular perfect shuffles, in accordance with various aspects of the present disclosure.

FIG. 7 illustrates a portion of the table shown in FIG. 6 comparing the Benes sequence to inverse perfect shuffle sequence, in accordance with various aspects of the present disclosure.

FIG. 8 is a block diagram illustrating a simplified inverse and regular perfect shuffle combination network, in accordance with various aspects of the present disclosure.

FIG. 9 is a flow diagram illustrating an example process performed, for example, by a computing device, in accordance with various aspects of the present disclosure.

FIG. 10 is a block diagram showing an exemplary wireless communications system in which a configuration of the present disclosure may be advantageously employed.

FIG. 11 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Neural network processing may be performed with various computing devices, for example, to detect objects. When detecting objects, it may be desirable to rank the detected objects by employing sorting techniques. Existing sorting techniques, however, may become a performance bottleneck. Processors of computing devices may also perform permutation operations other than sorting. For example, parallel processing techniques may be employed for dynamically accessing memory, polynomial evaluations, etc. It would be desirable to improve the processing speed for performing these types of permutations. It would also be desirable to reduce the area for a permutation network implemented in a processing unit, such as a vector processor. For example, a parallel processor, such as a single instruction, multiple data (SIMD) processor, may employ an improved shuffle exchange network to improve operations, such as sorting.

According to aspects of the present disclosure, a shuffle exchange network generates a full set of permutations for a sequence length of a power of two without modifying the network. The shuffle exchange network can be as fast as a Benes network with some modifications. In some aspects, the latency of the network reduces to an order of log N (e.g., O(log(N))) with only an order on N (e.g., O(N)) switches, as opposed to O(N log N) switches required by the Benes network. A first proposed network can achieve an O((log N)²) latency. A modified version of the network achieves a latency of O(log N).

Aspects of the present disclosure introduce a method where control bit computation is performed ahead of time for a given permutation. These aspects start from a perfect shuffle and add the control to arrive at the proposed design.

The perfect shuffle can be described mathematically as:

$$P ( i ) = \{ \begin{matrix}2 i , & 0 \leq i \leq N / 2 - 1 \\ 2 i + 1 - N , & N / 2 \leq i \leq N - 1\end{matrix} .$$

An inverse operation performs the original permutations in reverse order. The inverse perfect shuffle network (p⁻¹) can be described mathematically as:

$$P ( i ) = \{ \begin{matrix}i / 2 , & i \%2 == 0 \\ ( i + N - 1 ) / 2 , & i \%2 == 1\end{matrix} ,$$

where % represents a modulo operation.

Aspects of the present disclosure introduce a new network, including a first quantity of inverse perfect shuffle operations followed by a second quantity of perfect shuffle operations. In some aspects, the network is implemented on hardware to achieve both the inverse perfect shuffle and the perfect shuffle.

Particular aspects of the subject matter described in this disclosure can be implemented to realize one or more of the following potential advantages. In some examples, the described techniques, such as sequencing inverse perfect shuffles with perfect shuffles, may improve processing speed and reduce a number of switches for performing permutation operations.

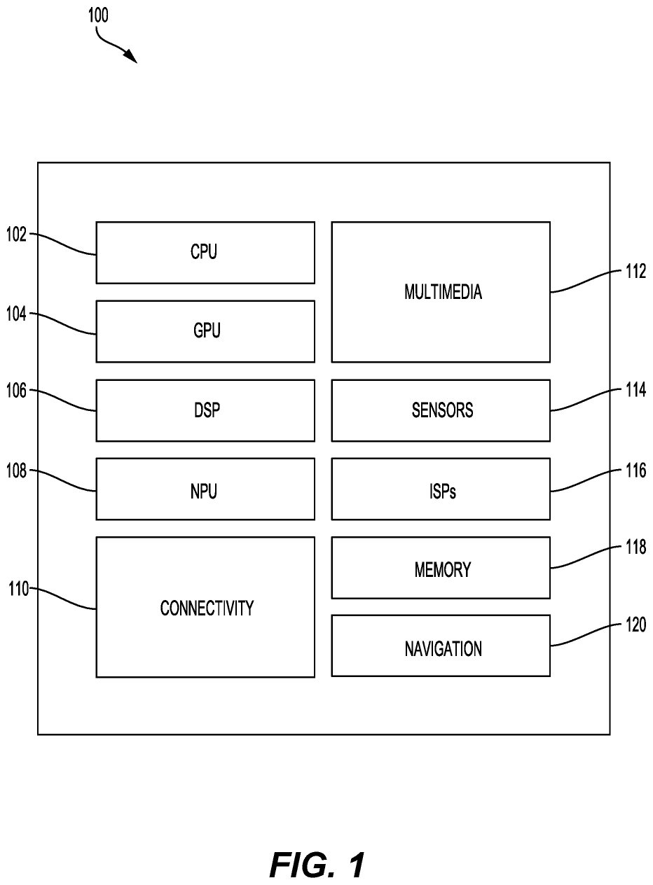

FIG. 1 illustrates an example implementation of a host system-on-a-chip (SoC) 100, capable of executing a shuffle exchange network, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

According to aspects of the present disclosure, a computing device includes means for performing a first series of inverse shuffle operations on an input sequence to generate an intermediate sequence. The computing device may include means for performing a second series of shuffle operations on the intermediate sequence to generate an output sequence that is a specified permutation of the input sequence. In one configuration, the performing means may be the CPU, GPU, DSP, NPU, ISP, connectivity module, and/or memory, as shown in FIG. 1. In other aspects, the aforementioned means may be any structure or any material configured to perform the functions recited by the aforementioned means.

Automotive and robotics domains may specify a system to detect objects, for example, for safely navigating through an environment. To enable safe navigation, the system ranks different hurdles. For example, a vehicle may determine a distance of each object, of a group of objects, from the vehicle by ranking the group of objects. Connected homes may be monitored by intelligent systems that engage in productivity trade-off computations to ensure reliable connectivity at a low cost. The trade-offs specify frequent ranking of possible outcomes. Real-time artificial intelligence (AI) software applications that run on mobile platforms frequently rank various content. In all of these scenarios, it would be desirable to improve the processing speed for the ranking operation.

Various neural networks (NNs) implement a TopK operation that performs a sorting operation and returns the top K values from N elements in a sorted fashion. This operation is key in object detection tasks where the neural network detects the most interesting objects from a group of identifiable objects in a scene. Currently, the TopK operation is among the costliest operations performed by a neural network (e.g., model), in terms of time, accounting for 10% of the neural network's runtime. If the values of N and K are greater than threshold values, optimal solutions may be impractical and scalars are employed instead. In other words, the fallback option is an optimal single thread solution of a heap sort or a merge sort. That is, the single instruction, multiple data (SIMD)-based function may be impractical after the thresholds, and non SIMD-based optimal functions are then invoked.

A TopK operation may employ a bitonic sorting process. The bitonic sorting process may be efficiently implemented on a parallel processor, such as a single instruction, multiple data (SIMD) processor. The technique may be scaled for larger values of K and N, while also improving performance. As noted above, the sorting operations may cause performance bottlenecks. If bottlenecks remain, hardware processors for executing soring operations are limited, in time or performance. Other permutation operations, such as dynamically accessing memory may also suffer from processing bottlenecks. Aspects of the present disclosure speed up permutation operations by more efficiently implementing a shuffle exchange network.

According to aspects of the present disclosure, a shuffle exchange network generates a full set of permutations for a sequence length of a power of two without modifying the network. The shuffle exchange network can be as fast as a Benes network with some modifications. In some aspects, the latency of the network reduces to an order of log N (e.g., O(log(N))) with only an order on N (e.g., O(N)) switches, as opposed to O(N log N) switches required by the Benes network. A first proposed network can achieve an O((log N)²) latency. A modified version of the network achieves a latency of O(log N).

Shuffle exchange networks may execute parallel sorting algorithms and dynamic memory access. A perfect shuffle followed by compare and exchange modules may also implement various tasks such as parallel sorting, polynomial evaluation, etc. A first proposed shuffle exchange network can generate all permutations with O((log N)²) latency and a variation of the same network can generate all the permutations for a power of two length sequence in O(log(N)) time. The recursive structure of the shuffle exchange network keeps the consumption of switches (e.g., exchange modules) to O(N). The controls for the proposed networks correspond to the Benes network, for which the control computation is well documented. For some classes of permutations, the shuffle exchange network may be configured at runtime.

The shuffle exchange network was introduced by H. S. Stone and Tomas Lang, building on the perfect shuffle concept introduced by H. S. Stone. Lang and Stone proposed that a few important permutations can be realized in O(log 2(N)) steps using a shuffle exchange network with a control mechanism. In this case, the control variables at step k are determined by a Boolean operation on control variables at step k−1.

Aspects of the present disclosure introduce a method where control bit computation is performed ahead of time for a given permutation. These aspects start from the perfect shuffle and add the control to arrive at the proposed design. The perfect shuffle can be illustrated by a deck of cards. As an example, a deck of cards is divided into two equal parts. The perfect shuffle results in cards from both halves of the deck being perfectly interleaved.

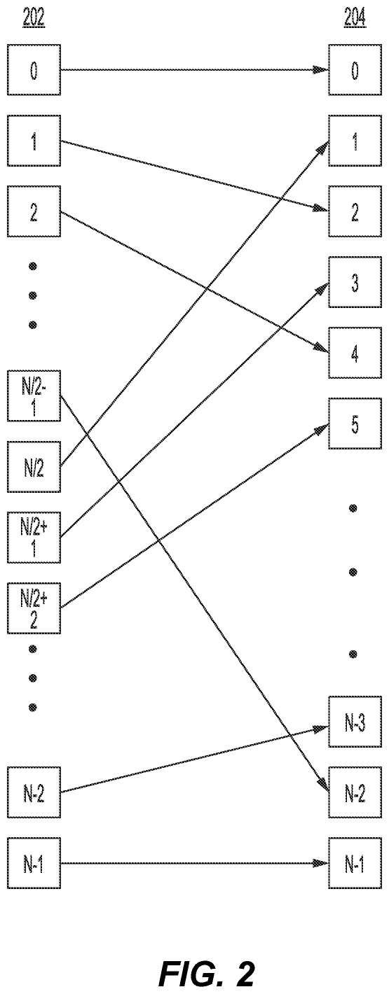

FIG. 2 is a block diagram illustrating an example of a perfect shuffle operation. The example shown in FIG. 2 is for a sequence of length N. In the example of FIG. 2, a first column shows an input sequence 202 of N blocks (block 0 to block N−1) before a shuffle operation. A second column shows an output sequence 204 of the N blocks after the shuffle operation. In the example of FIG. 2, the block labeled 0 in the input sequence 202 ends in the block labeled 0 in the output sequence 204 after the shuffle. The block labeled 1 in the input sequence 202 ends in the block labeled 2 in the output sequence 204 after the shuffle. The block labeled 2 in the input sequence 202 ends in the block labeled 4 in the output sequence 204 after the shuffle. The block labeled N/2 in the input sequence 202 ends in the block labeled 1 in the output sequence 204 after the shuffle, and so forth until the N blocks in the input sequence 202 are interleaved resulting in the output sequence 204.

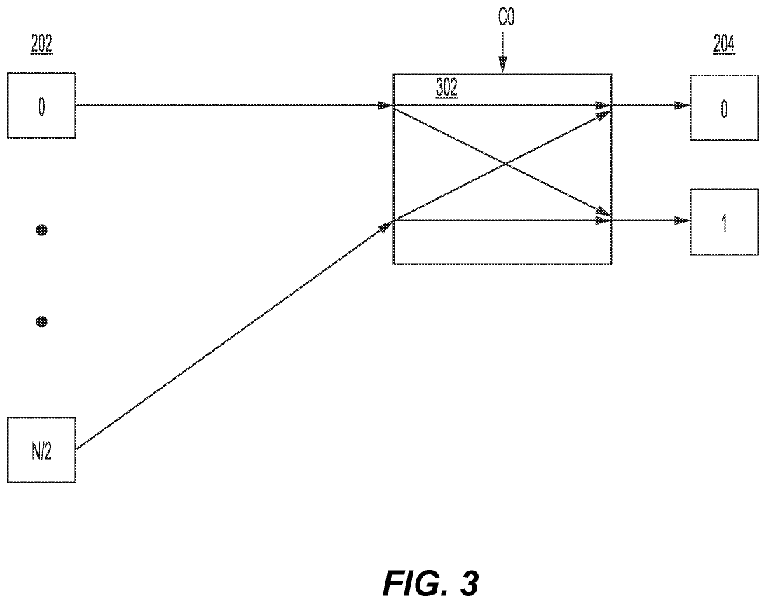

The perfect shuffle operation, however, cannot generate all permutations of a given sequence even though the perfect shuffle operation can generate some very important sequences, such as interleaving. To expand the range of the shuffle, an exchange unit can be added to swap based on a control bit. FIG. 3 is a block diagram illustrating an example of an exchange unit, in accordance with various aspects of the present disclosure. In the example of FIG. 2, blocks 0 and N/2 from the input sequence 202 transfer to locations 0 and 1 in the output sequence 204, respectively. As shown in FIG. 3, by adding an exchange unit 302, the values of 0 and N/2 in the input sequence 202 received at the exchange unit 302 and can be swapped, based on a control bit CO, before going to either 0 or 1 in the output sequence 204. Thus, the exchange unit 302 swaps output based on the control bit CO.

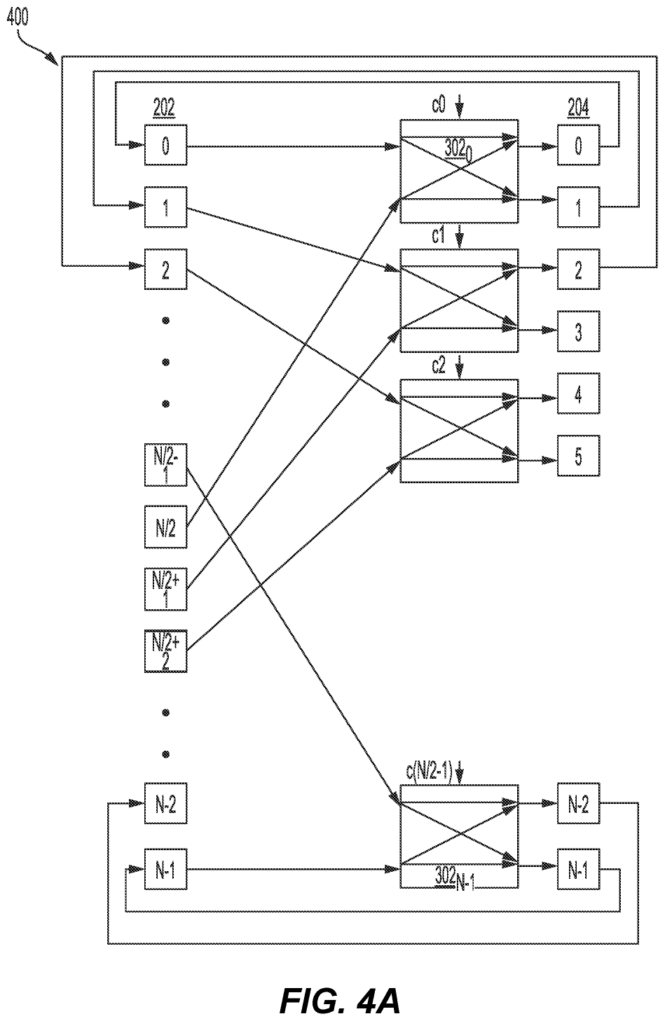

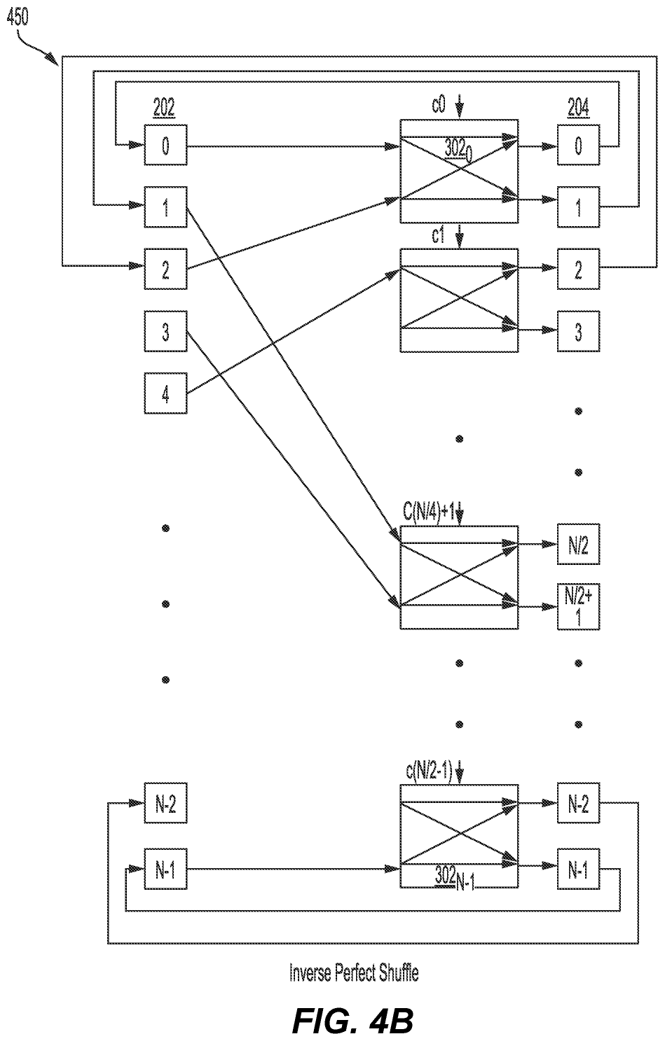

FIG. 4A is a block diagram illustrating an example of a perfect shuffle exchange network 400, in accordance with various aspects of the present disclosure. In the example of FIG. 4A, a design of the perfect shuffle exchange network 400 includes exchange units 302₀ . . . 302_{N-1}. An input sequence 202 runs through the same network as many times as needed to arrive at a desired permutation. That is, the output sequence 204 becomes the input sequence 202 in the next iteration. The perfect shuffle exchange network 400 can generate all permutations for a sequence length of a power of two, and saves area while obtaining the desired permutation in O((log N)²) steps.

Group theory will now be discussed in order to prove that all sequences can be generated by the perfect shuffle exchange network 400 for any sequence length that is a perfect power of two, as is commonly the case in vector processors. Denote p as the permutation group for the perfect shuffle and let sᵢ indicate the permutation group for exchange block i. For instance, applying so on the sequence 0, 1, 2, 3, 4, 5, . . . N−1, results in the sequence 1, 0, 2, 3, 4, 5, . . . N−1 as the first two elements swap. The perfect shuffle exchange network 400 can be represented as a product of the permutations: p(s₀)^{t0}(s1)^{k1}(s₂)^{k2} . . . (sₙ)^{kn}, where kᵢ is either 0 or 1 with a swap occurring if the control bit is one. Each iteration of the network has exactly one instance of p and at maximum one instance of sᵢ for all i from 0 to N/2.

It is known that a perfect shuffle is periodic. If a perfect shuffle is repeatedly performed on sequences, the original sequence reappears after a few iterations. The number of shuffles(k) needed to restore the original order of a sequence of length n, called the order of the sequence k, is given by 2^{k}≡1(mod(n−1)). If n is a perfect power of two then k=log 2n.

For example, if a perfect shuffle is performed on a set of eight numbers three times, then the original sequence is obtained. Represent this value as p³=e, where e is the identity sequence. This also implies that the inverse perfect shuffle p⁻¹=p² in this scenario. In general, if a sequence of length n has an order k, then p^{k}=e for that sequence. For the described exchange modules, the order is two, as the original sequence is restored if a pair exchanges twice. Thus, sᵢ²=e. Accordingly, any combination of p and sᵢ can be achieved by the perfect shuffle exchange network 400 by making use of this order. For example, if the goal is a permutation of p²s₃s₄ps₀, the permutation is obtained by the perfect shuffle exchange network 400 by formulating the permutation as [p][ps₃s₄][ps₀]. If only the permutation group so is performed, the permutation can be represented as p^{k}s0 as p^{k}=e and run using the perfect shuffle exchange network 400 [p][p] . . . [p][ps₀] where p is repeated k−1 times followed by a ps₀. Periodicity enables the flexibility to achieve any combination of p and sᵢ using the perfect shuffle exchange network 400.

The perfect shuffle for a sequence length of a power of two has an interesting property in that the new indices after shuffle are cyclic shifted to the left in the binary format compared to the original indices. For the case of a length eight sequence:
000→000
001→100
010→001
011→101
100→010
101→110
110→011
111→111

This shift is a general rule for all power of two sequences and can be observed from the formulation of the perfect shuffle:

$$P ( i ) = \{ \begin{matrix}2 i , & 0 \leq i \leq N / 2 - 1 \\ 2 i + 1 - N , & N / 2 \leq i \leq N - 1\end{matrix} .$$

If N is a perfect power of two, then it can be observed for the first half of the sequence, the most significant bit would be 0 and would be 1 for the second half of the sequence. For the first half of the sequence, the index is doubled (P(i)=2i), which is a left shift by 1.

For the second half of the sequence, the index mapping (P(i)=2i+1−N) is a cyclic shift. To prove this, assume that N=2^{k} and i=2^{k-1}+j and i as the most significant bit corresponding to 2^{k-1} would be 1. Also, j contains all the bits of i except the most significant bit, which is 1. So, P(i)=2i+1−N=2(2^{k-1}+j)+1−N=2^{k}+2j+1−N=2j+1. Now, j has all the bits of i except the most significant one, so 2j is a left shifted version by one, and adding one can be interpreted as adding the most significant bit to the first bit, making it effectively a cyclic shift. The cyclic shift property for sequences having a length of a power of two helps to prove that all sequences can be achieved.

Next, it is proven that any two elements can be swapped using p and sᵢ. This is important as any permutation of a sequence can be achieved by continuous swapping of pairs of elements. To prove any two elements can be swapped, indices are written in a binary format. It should also be noted that the effect of the permutation group for the exchange block i (e.g., sᵢ) on indices on which they operate is that the last bit is toggled. For example, performing an operation on so interchanges 0 and 1 effectively toggling the last bit.

Swapping two elements is possible by bringing these two indices to index 0 and 1 and swapping them by performing an so permutation. Starting with the first index and attempting to bring it to 0 using p and sᵢ, the process is as follows:

As long as the index is not 0, repeat the following:
(1) If the last bit of the index is 1, perform a corresponding sᵢ operation to make the last bit 0.
(2) If the last bit is 0, perform a perfect shuffle(p).

This process ensures that all bits are set to 0 and the index is brought to 0. Step two affects a cyclic shift and traverses the full length of the sequence, and each 1 is set to 0 with the swap in step one.

Next, the second index is swapped to index number 1. A similar procedure occurs and none of these permutations change the first index's location at 0 as the permutation group for the perfect shuffle p and the permutation group for the exchange block sᵢ(i≠0) do not change the position of 0. Thus, the permutation group for the exchange block 0 (s₀) does not come into play as the following procedure is performed only when the final index is not 1. The method for this procedure remains the same as the previous case except the procedure is performed as long as the index is not 1. This method ensures that all bits are set to 0 except one that brings the index to 1. In the next step, the permutation group for the exchange block 0 (s₀) swaps between 0 and 1.

Next, the inverse operation occurs for all the permutations previously performed to set the indices at 0 and 1 in the first place. The inverse operation performs the original permutations in reverse order. The inverse operation places all the indices in their original location and swaps the intended indices. For example, in the previous discussion, the following sequence of permutations brought the indices to 0 and 1−sₖ₀psₖ₁p³sₖ₂p²sₖ₃. The final sequence to swap any two elements is as follows: [sₖ₀ psₖ₁ p³sₖ₂ p²sₖ₃][s₀]sₖ₃⁻¹ p⁻²sₖ₂⁻¹ p⁻³sₖ₁⁻¹ p⁻¹sₖ₀⁻¹].

As noted above, sₖᵢ⁻¹=sₖᵢ due to its order of two and p^{-a}=p^{k-a} where k is the order of the perfect shuffle. Consequently, it can be seen that the proposed shuffle exchange network 400 can swap any two elements. Because any permutation can be achieved by swapping pairs of elements, any permutation can be achieved using the proposed shuffle exchange network 400.

FIG. 4B is a block diagram illustrating an example of an inverse perfect shuffle exchange network, in accordance with various aspects of the present disclosure. In the example of FIG. 4B, a design of the inverse perfect shuffle exchange network 450 includes exchange units 302₀ . . . 302_{N-1}. An input sequence 202 runs through the same network as many times as needed to arrive at a desired permutation. That is, the output sequence 204 becomes the input sequence 202 in the next iteration. The inverse perfect shuffle network (p⁻¹) can be described mathematically as:

$$P ( i ) = \{ \begin{matrix}i / 2 , & i \%2 == 0 \\ ( i + N - 1 ) / 2 , & i \%2 == 1\end{matrix} ,$$

where % represents the modulo operation.

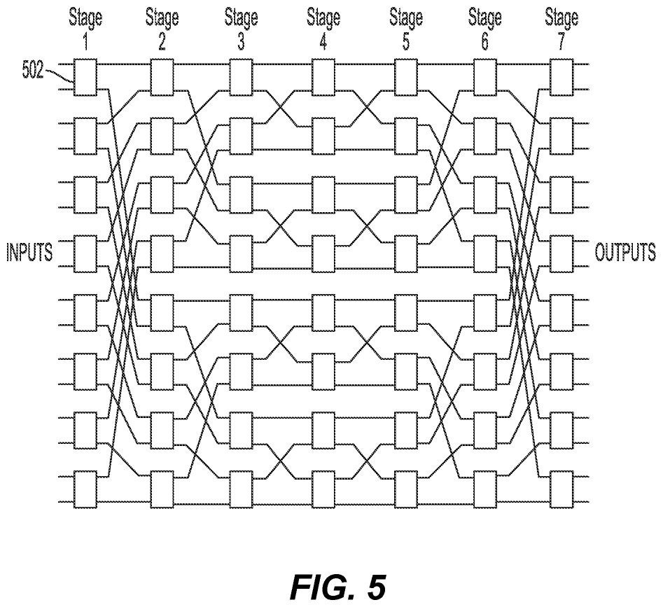

The latency for the perfect shuffle exchange network 400 and inverse perfect shuffle exchange network 450 can each be O((log N)²). An improved network will now be discussed to reduce the latency. A Benes network is a non-blocking interconnected network that has 2 log₂ N−1 stages. FIG. 5 is a block diagram illustrating an example of a Benes network. The Benes network in the example of FIG. 5 has an input sequence length of 16, and thus, seven stages. The Benes network is able to arrive at all possible permutations using N log N switches 502 (only one switch 502 is illustrated for ease of explanation). The Benes network has multiple stages of shuffling, with the shuffle blocks becoming smaller for log₂ N stages and reversing thereafter. At each stage, the switch 502 can flip to exchange the values.

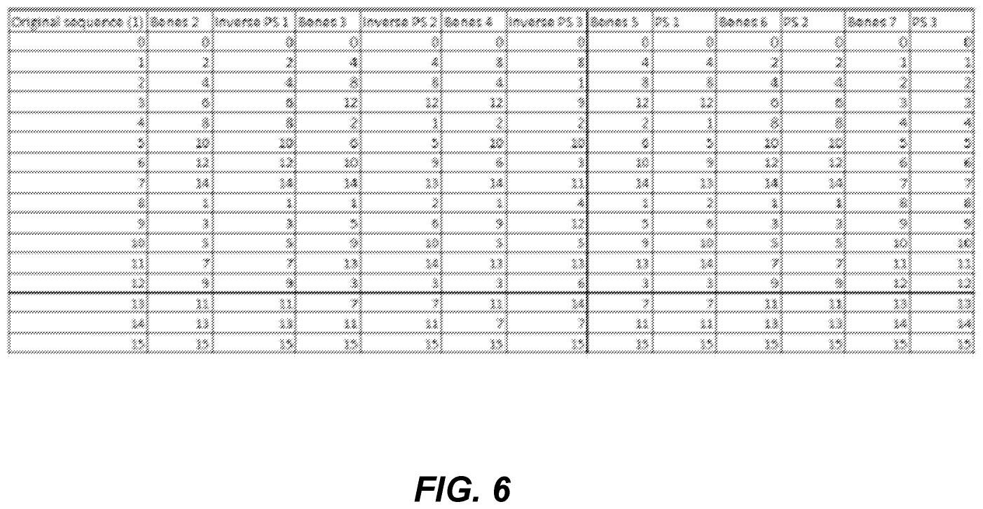

A correspondence between the Benes network of FIG. 5 and a new network including a sequence of inverse perfect shuffle and perfect shuffle operations is now discussed with reference to FIG. 6. FIG. 6 is a table illustrating a Benes sequence comparison to a sequence of inverse and regular perfect shuffles, in accordance with various aspects of the present disclosure. The new shuffle exchange network (e.g., sequence of inverse and regular perfect shuffles) shown in FIG. 6 includes three inverse shuffles operations (Inverse PS 1, Inverse PS 2, Inverse PS 3) followed by three perfect shuffles (PS 1, PS 2, PS 3). The Benes network includes seven stages (Original Sequence (1), Benes 2, Benes 3, Benes 4, Benes 5, Benes 6, Benes 7), as also seen in FIG. 5. In the Benes network, the sequence in the first stage is the same as a sequence resulting from an inverse perfect shuffle, the second stage sequence of the Benes network corresponds to an inverse perfect shuffle of the two half sequences, the third stage sequence of the Benes network corresponds to an inverse perfect shuffle for four quarter sequences, and the remaining stage sequences of the Benes network correspond to perfect shuffles in reverse order.

An example with numbers will now be discussed to better illustrate aspects of the present disclosure. In the example of FIG. 6, an original input sequence includes the values 0 to 15, as seen in the first column of the table in FIG. 6. The input sequence is common to the first stage of both the Benes network and the new network. In stage two of the Benes network (Benes 2), the sequence becomes 0, 2, 4, 6, 8, 10, 12, 14, 1, 3, 5, 7, 9, 11, 13, 15. In stage three of the Benes network (Benes 3), the sequence becomes 0, 4, 8, 12, 2, 6, 10, 14, 1, 5, 9, 13, 3, 7, 11, 15.

In FIG. 6, the inverse perfect shuffle stage two is represented as Inverse PS 1, and the inverse perfect shuffle stage three is represented as Inverse PS 2 because the first inverse perfect shuffle is referred to as stage 0. The inverse perfect shuffle stage two (Inverse PS 1) has the same sequence as stage two of the Benes network (Benes 2). The inverse perfect shuffle stage three (Inverse PS 2), however, does not have the same sequence as stage three of the Benes network (Benes 3).

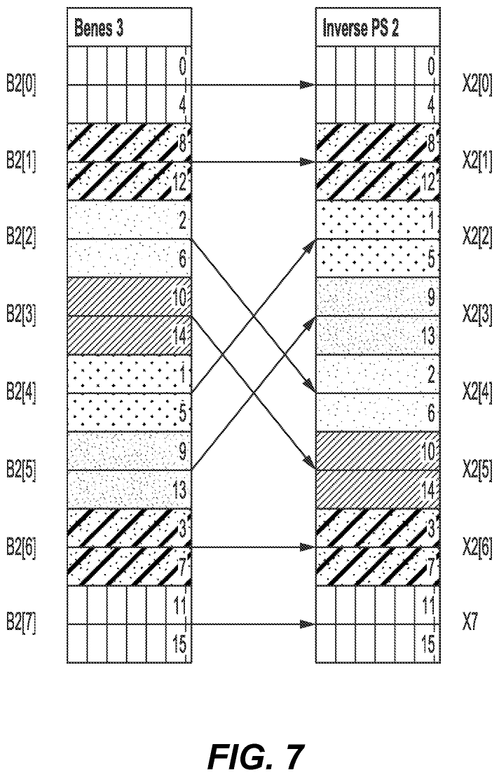

To better illustrate this difference, FIG. 7 illustrates a portion of the table shown in FIG. 6 comparing the Benes sequence to the inverse perfect shuffle sequence in accordance with various aspects of the present disclosure. As seen in FIGS. 6 and 7, stage three of the inverse perfect shuffle (Inverse PS 2) results in a sequence of 0, 4, 8, 12, 1, 5, 9, 13, 2, 6, 10, 14, 3, 7, 11, 15, which differs from the stage three sequence of the Benes network.

There are seven stages of the Benes network, including the starting original sequence that is common to both the Benes network and the new shuffle exchange network. As can be observed from FIG. 6, the sequences match at stages 1, 2, 6, and 7 of the Benes network. For stages 3, 4, and 5 of the Benes network, the sequences do not match. The switches that are toggled in the Benes network, however, can also be toggled at the corresponding location in the new shuffle exchange network thereby ending up with the same final sequence. There is a one-to-one correspondence between each switch of every stage of the Benes network and a switch in the same stage of the new shuffle exchange network. The controls for the new shuffle exchange network can be derived from the Benes network.

For example, let the controls for the Benes network be represented as B0, B1, B2, B3, B4, B5 where each Bi consists of eight Boolean values to control the eight switches 502. Similarly, let the controls for the new shuffle exchange network at each stage be represented as X0, X1, X2, X3, X4, X5. The table shown in FIG. 6 illustrates when all the controls are set to 0. The relation between the controls for the two networks is as follows where X2[3] represents the third Boolean value for the second stage of the new shuffle exchange network:
X0=B0
X1=B1
X2=B2, except X2[2]=B2[4], X2[3]=B2[5], X2[4]=B2[2], and X2[5]=B2[3]
X3=B3, except X3[1]=B3[4], X3[3]=B3[6], X3[4]=B3[1], and X3[6]=B3[3]
X4=B4, except X4[2]=B4[4], X4[3]=B4[5], X4[4]=B4[2], and X4[5]=B4[3]
X5=B5.

The logic for shuffling the controls can be seen in the table of FIG. 6, but to illustrate better, the control information at stage two is discussed in more detail with reference to FIG. 7. To derive the control information X2 for the new shuffle exchange network from the Benes network control information B2, the following assignment occurs:
X2=B2, except X2[2]=B2[4], X2[3]=B2[5], X2[4]=B2[2], and X2[5]=B2[3].

The reasoning can be better seen from FIG. 7, which has the stages cropped and extracted from FIG. 6. As seen in FIG. 7, the first Benes Boolean value B2[0] is the same as the first inverse perfect shuffle Boolean value X2[0] and is not listed as an exception. Similarly, the second Benes Boolean value B2[1] is the same as the second inverse perfect shuffle Boolean value X2[1]. The third Benes Boolean value B2[2] is not the same as the third inverse perfect shuffle Boolean value X2[2], however, the third Benes Boolean value B2[2] is the same as the fifth inverse perfect shuffle Boolean value X2[4], in other words B2[2]=X2[4]. Thus, the same exchange that happens at one gate in the Benes network maps to a corresponding gate in the new shuffle exchange network. The same logic can be used for all stages, and by extension, for a network of any given length (as long as the input sequence is a power of two). Because the Benes network can achieve any sequence, the new combination network having the inverse perfect shuffles followed by the regular perfect shuffles can generate all sequences with log₂ N inverse perfect shuffles and log₂ N perfect shuffles.

In order to generate any permutation using the new combination shuffle exchange network, the latency is determined based on the log₂ N inverse perfect shuffles and the log₂ N perfect shuffles. The exchange modules correspond to switches that occur at each stage. The inverse perfect shuffle p⁻¹ can be achieved by the new network by p^{k-1} iterations where k is the order and k=log₂ N when N is a perfect power of two. Thus, each inverse perfect shuffle takes log₂ N turns on the network and because the above sequence has log₂ N inverse perfect shuffles, the overall latency is ((log₂ N)²+log₂ N), which is O((log N)²).

According to aspects of the present disclosure, the quantity of switches used is O(N), which compares favorably with the Benes network where the quantity of switches is O(N log N). The new shuffle exchange network consumes fewer switches and hence less area on the chip for the same functionality. The lower number of switches leads to fewer transistors, and by extension, to lower static power consumption.

The latency of the new network is O((log N)²) compared to O(log N) for a traditional Benes network. The number of switches, however, is better, in the new network taking O(N) switches compared to O(N log N) switches for the Benes network. According to further aspects of the present disclosure, the new network may be modified to keep the latency at O(log N) and the switches at O(N). In these aspects, the network is implemented on hardware to also achieve the inverse perfect shuffle. The implementation takes the same amount of hardware as the perfect shuffle and simplifies the use case implementation for the first half stages. The inverse perfect shuffle p⁻¹ operates as its own shuffle, similar to the perfect shuffle p instead of performing p^{k-1} (where k is the order of perfect shuffle).

As a result of the modification, the latency is log 2N+log 2N=2 log 2N, where the first log 2N corresponds to the first half of inverse perfect shuffles and the second log 2N corresponds to the second half of perfect shuffles. The latency reduces to O(log N), the same as the latency of the Benes network. The cost incurred for the modification is the new network for inverse perfect shuffle, which brings the total number of switches to 2N, which is still O(N), thus keeping the advantage in switches/area while matching latency with the Benes network.

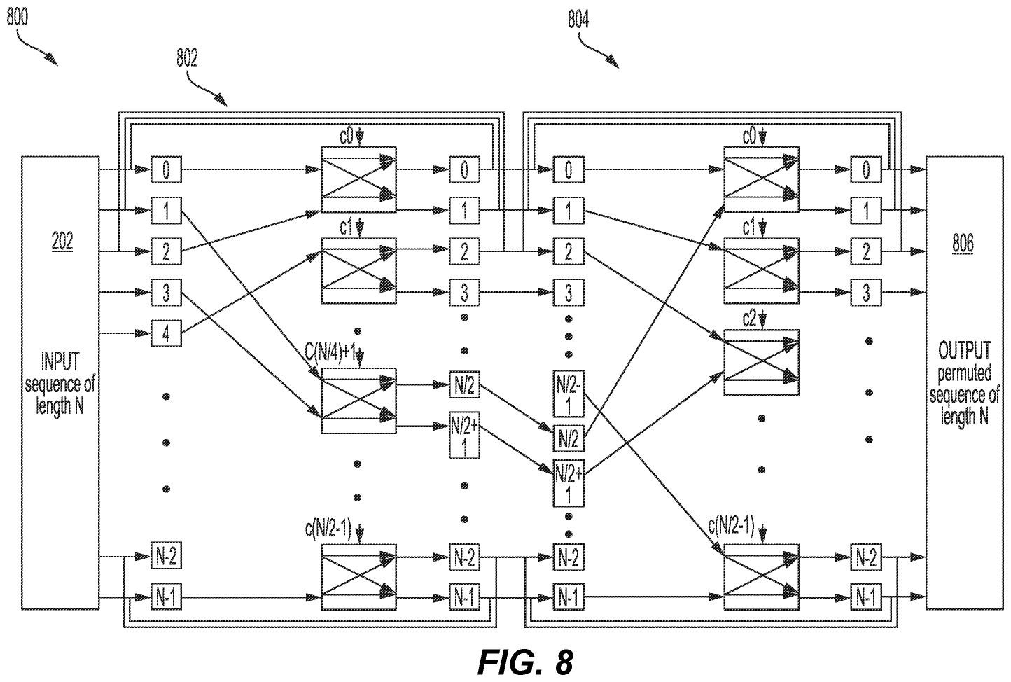

FIG. 8 is a block diagram illustrating a simplified inverse and regular perfect shuffle combination network, in accordance with various aspects of the present disclosure. In the example of FIG. 8, the combination network 800 includes an inverse perfect shuffle exchange network 802 followed by a perfect shuffle exchange network 804. The combination network 800 is a simplified version of the combination network discussed with reference to FIG. 6, including only a single stage for the inverse perfect shuffle exchange network 802 and a single stage for the perfect shuffle exchange network 804. In the simplified example of FIG. 8, the inverse perfect shuffle exchange network 802 runs log 2N times on the input sequence 202 of N blocks (block 0 to block N−1) to generate an intermediate output/sequence that passes to the perfect shuffle exchange network 804. The perfect shuffle exchange network 804 runs log 2N times on the intermediate output to generate a final output 806 that is a permuted sequence of length N. At each stage of the inverse perfect shuffle exchange network 802 and the perfect shuffle exchange network 804, control bits CO to C(N/2−1) control each respective exchange block to determine whether an exchange happens within the corresponding block.

Advantages of this proposed combination network include a reduced number of switches, which improves the area as well as the static power consumption. Although the application for this network may be limited to sequences that are a power of two, which may seem like a significant limitation, in fact, power of two length sequences are the default on hardware performing permutations on sequences of SIMD (single instruction, multiple data) length. SIMD for vector processors is almost always a power of two, for example, a digital signal processor (DSP) with an SIMD of 128 bytes being an example.

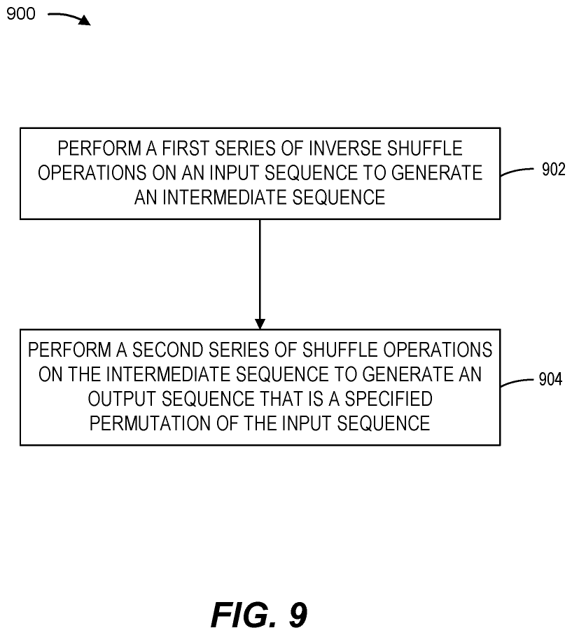

FIG. 9 is a flow diagram illustrating an example process 900 performed, for example, by a computing device, in accordance with various aspects of the present disclosure. The example process 900 is an example of performing shuffle exchange operations. As shown in FIG. 9, in some aspects, the process 900 may include performing a first series of inverse shuffle operations on an input sequence to generate an intermediate sequence (block 902). For example, the first series of inverse perfect shuffle operations has an order of operations. In some aspects, the first stage has Log₂ N steps, where N is a length of the input sequence. Each of the first series of inverse perfect shuffle operations may include a first set of exchanges, a quantity of the first set of exchanges being equal to N/2, where N is a length of the input sequence.

In some aspects, the process 900 may include performing a second series of shuffle operations on the intermediate sequence to generate an output sequence that is a specified permutation of the input sequence (block 904). For example, the second series of perfect shuffle operations has a reverse order of operations. In some aspects, the first series of inverse perfect shuffle operations occur in a first stage and the second series of perfect shuffle operations occur in a subsequent second stage. In other aspects, the second stage has Log₂ N steps, where N is a length of the input sequence. Each of the second series of perfect shuffle operations may include a second set of exchanges, a quantity of the second plurality of exchanges being equal to N/2, where N is a length of the input sequence.

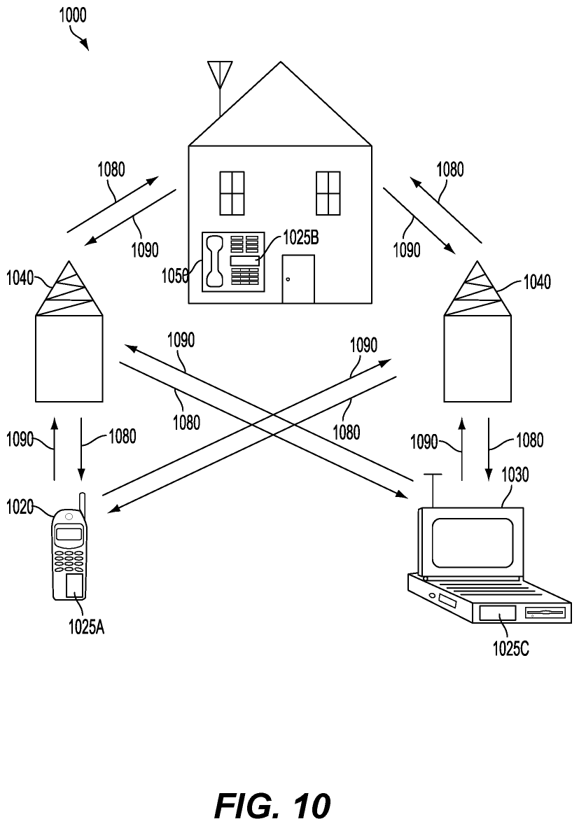

FIG. 10 is a block diagram showing an exemplary wireless communications system 1000, in which an aspect of the present disclosure may be advantageously employed. For purposes of illustration, FIG. 10 shows three remote units 1020, 1030, and 1050, and two base stations 1040. It will be recognized that wireless communications systems may have many more remote units and base stations. Remote units 1020, 1030, and 1050 include integrated circuit (IC) devices 1025A, 1025B, and 1025C that include the disclosed shuffle exchange network. It will be recognized that other devices may also include the disclosed shuffle exchange network, such as the base stations, switching devices, and network equipment. FIG. 10 shows forward link signals 1080 from the base stations 1040 to the remote units 1020, 1030, and 1050, and reverse link signals 990 from the remote units 1020, 1030, and 1050 to the base stations 1040.

In FIG. 10, remote unit 1020 is shown as a mobile telephone, remote unit 1030 is shown as a portable computer, and remote unit 1050 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 9 illustrates remote units according to the aspects of the present disclosure, the disclosure is not limited to these exemplary illustrated units. Aspects of the present disclosure may be suitably employed in many devices, which include the disclosed shuffle exchange network.

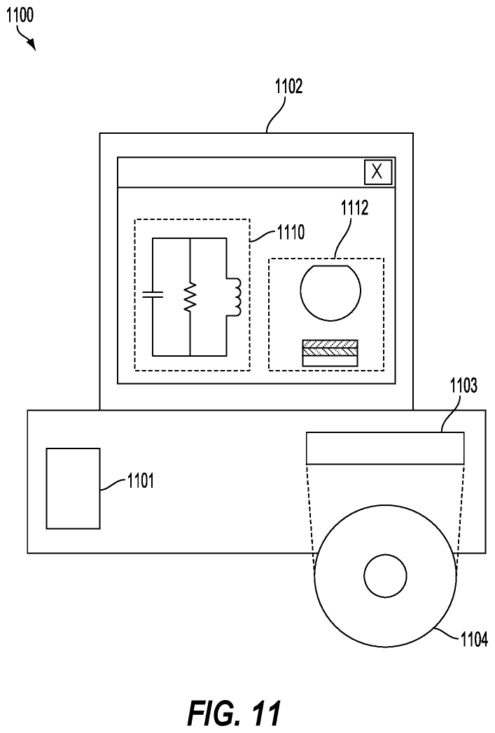

FIG. 11 is a block diagram illustrating a design workstation 1100 used for circuit, layout, and logic design of a semiconductor component, such as the shuffle exchange network disclosed above. The design workstation 1100 includes a hard disk 1101 containing operating system software, support files, and design software such as Cadence or OrCAD. The design workstation 1100 also includes a display 1102 to facilitate design of a circuit 1110 or a semiconductor component 1112, such as the shuffle exchange network. A storage medium 1104 is provided for tangibly storing the design of the circuit 1110 or the semiconductor component 1112 (e.g., the PLD). The design of the circuit 1110 or the semiconductor component 1112 may be stored on the storage medium 1104 in a file format such as GDSII or GERBER. The storage medium 1104 may be a CD-ROM, DVD, hard disk, flash memory, or other appropriate device. Furthermore, the design workstation 1100 includes a drive apparatus 1103 for accepting input from or writing output to the storage medium 1104.

Data recorded on the storage medium 1104 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1104 facilitates the design of the circuit 1110 or the semiconductor component 1112 by decreasing the number of processes for designing semiconductor wafers.

### Example Aspects

Aspect 1: A shuffle exchange network, comprising: a first circuit comprising a first stage comprising a first plurality of elements storing a first set of sequences of length N, and a first plurality of exchange units each receiving input from a first pair of the first plurality of elements, each of the first plurality of exchange units selectively coupling the first pair of the first plurality of elements in the first stage to a second pair of the first plurality of elements that is fed back to the first stage, the first plurality of exchange units receiving input from each pair of the first plurality of elements based on a perfect shuffle operation.

Aspect 2: The shuffle exchange network of Aspect 1, further comprising a second circuit providing output to the first circuit, the second circuit comprising a second stage preceding the first stage, the second stage comprising a second plurality of elements storing a second set of sequences of length N, and a second plurality of exchange units each receiving input from a first pair of the second plurality of elements, each of the second plurality of exchange units selectively coupling the first pair of the second plurality of elements in the second stage to a second pair of the second plurality of elements that is fed back to the second stage, the second plurality of exchange units receiving input from each pair of the second plurality of elements based on an inverse perfect shuffle operation.

Aspect 3: The shuffle exchange network of Aspect 1 or 2, in which the inverse perfect shuffle operation has an order of operations for the second stage and the perfect shuffle operation has a reverse order of operations for the first stage.

Aspect 4: The shuffle exchange network of any of the preceding Aspects, in which each exchange unit of the first plurality of exchange units and of the second plurality of exchange units comprises a plurality of transistors.

Aspect 5: The shuffle exchange network of any of the preceding Aspects, in which the first plurality of exchange units comprises N/2 exchange units, and the second plurality of exchange units comprises N/2 exchange units.

Aspect 6: The shuffle exchange network of any of the preceding Aspects, in which the second stage has a latency of Log 2N steps.

Aspect 7: The shuffle exchange network of any of the preceding Aspects, in which the first stage has a latency of Log 2N steps.

Aspect 8: A processor-implemented method, comprising: performing a first series of inverse shuffle operations on an input sequence to generate an intermediate sequence; and performing a second series of shuffle operations on the intermediate sequence to generate an output sequence that is a specified permutation of the input sequence.

Aspect 9: The processor-implemented method of Aspect 8, in which the first series of inverse perfect shuffle operations has an order of operations, and the second series of perfect shuffle operations has a reverse order of operations.

Aspect 10: The processor-implemented method of Aspect 8 or 9, in which the first series of inverse perfect shuffle operations occur in a first stage and the second series of perfect shuffle operations occur in a subsequent second stage.

Aspect 11: The processor-implemented method of any of the Aspects 8-10, in which the second stage has Log 2N steps, where N is a length of the input sequence.

Aspect 12: The processor-implemented method of any of the Aspects 8-11, in which the first stage has Log 2N steps, where N is a length of the input sequence.

Aspect 13: The processor-implemented method of any of the Aspects 8-12, in which each of the first series of inverse perfect shuffle operations comprises a first plurality of exchanges, a quantity of the first plurality of exchanges being equal to N/2; and each of the second series of perfect shuffle operations comprises a second plurality of exchanges, a quantity of the second plurality of exchanges being equal to N/2, where N is a length of the input sequence.

Aspect 14: An apparatus, comprising: means for performing a first series of inverse shuffle operations on an input sequence to generate an intermediate sequence; and means for performing a second series of shuffle operations on the intermediate sequence to generate an output sequence that is a specified permutation of the input sequence.

Aspect 15: The apparatus of Aspect 14, in which the first series of inverse perfect shuffle operations has an order of operations, and the second series of perfect shuffle operations has a reverse order of operations.

Aspect 16: The apparatus of Aspect 14 or 15, in which the first series of inverse perfect shuffle operations occur in a first stage and the second series of perfect shuffle operations occur in a subsequent second stage.

Aspect 17: The apparatus of any of the Aspects 14-16, in which the second stage has Log 2N steps, where N is a length of the input sequence.

Aspect 18: The apparatus of any of the Aspects 14-17, in which the first stage has Log 2N steps, where N is a length of the input sequence.

Aspect 19: The apparatus of any of the Aspects 14-18, in which each of the first series of inverse perfect shuffle operations comprises a first plurality of exchanges, a quantity of the first plurality of exchanges being equal to N/2; and each of the second series of perfect shuffle operations comprises a second plurality of exchanges, a quantity of the second plurality of exchanges being equal to N/2, where N is a length of the input sequence.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A shuffle exchange network, comprising:
a first circuit comprising a first stage comprising a first plurality of elements storing a first set of sequences of length N, and a first plurality of exchange units each receiving input from a first pair of the first plurality of elements, each of the first plurality of exchange units selectively coupling the first pair of the first plurality of elements in the first stage to a second pair of the first plurality of elements that is fed back to the first stage, the first plurality of exchange units receiving input from each pair of the first plurality of elements based on a perfect shuffle operation.

2. The shuffle exchange network of claim 1, further comprising a second circuit providing output to the first circuit, the second circuit comprising a second stage preceding the first stage, the second stage comprising a second plurality of elements storing a second set of sequences of length N, and a second plurality of exchange units each receiving input from a first pair of the second plurality of elements, each of the second plurality of exchange units selectively coupling the first pair of the second plurality of elements in the second stage to a second pair of the second plurality of elements that is fed back to the second stage, the second plurality of exchange units receiving input from each pair of the second plurality of elements based on an inverse perfect shuffle operation.

3. The shuffle exchange network of claim 2, in which the inverse perfect shuffle operation has an order of operations for the second stage and the perfect shuffle operation has a reverse order of operations for the first stage.

4. The shuffle exchange network of claim 2, in which each exchange unit of the first plurality of exchange units and of the second plurality of exchange units comprises a plurality of transistors.

5. The shuffle exchange network of claim 2, in which the first plurality of exchange units comprises N/2 exchange units, and the second plurality of exchange units comprises N/2 exchange units.

6. The shuffle exchange network of claim 2, in which the second stage has a latency of Log₂ N steps.

7. The shuffle exchange network of claim 6, in which the first stage has a latency of Log₂ N steps.

8. A processor-implemented method, comprising:
performing a first series of inverse shuffle operations on an input sequence to generate an intermediate sequence; and
performing a second series of shuffle operations on the intermediate sequence to generate an output sequence that is a specified permutation of the input sequence.

9. The processor-implemented method of claim 8, in which the first series of inverse perfect shuffle operations has an order of operations, and the second series of perfect shuffle operations has a reverse order of operations.

10. The processor-implemented method of claim 8, in which the first series of inverse perfect shuffle operations occur in a first stage and the second series of perfect shuffle operations occur in a subsequent second stage.

11. The processor-implemented method of claim 10, in which the second stage has Log₂ N steps, where N is a length of the input sequence.

12. The processor-implemented method of claim 10, in which the first stage has Log₂ N steps, where N is a length of the input sequence.

13. The processor-implemented method of claim 8, in which each of the first series of inverse perfect shuffle operations comprises a first plurality of exchanges, a quantity of the first plurality of exchanges being equal to N/2; and each of the second series of perfect shuffle operations comprises a second plurality of exchanges, a quantity of the second plurality of exchanges being equal to N/2, where N is a length of the input sequence.

14. An apparatus, comprising:
means for performing a first series of inverse shuffle operations on an input sequence to generate an intermediate sequence; and
means for performing a second series of shuffle operations on the intermediate sequence to generate an output sequence that is a specified permutation of the input sequence.

15. The apparatus of claim 14, in which the first series of inverse perfect shuffle operations has an order of operations, and the second series of perfect shuffle operations has a reverse order of operations.

16. The apparatus of claim 14, in which the first series of inverse perfect shuffle operations occur in a first stage and the second series of perfect shuffle operations occur in a subsequent second stage.

17. The apparatus of claim 16, in which the second stage has Log₂ N steps, where N is a length of the input sequence.

18. The apparatus of claim 16, in which the first stage has Log₂ N steps, where N is a length of the input sequence.

19. The apparatus of claim 14, in which each of the first series of inverse perfect shuffle operations comprises a first plurality of exchanges, a quantity of the first plurality of exchanges being equal to N/2; and each of the second series of perfect shuffle operations comprises a second plurality of exchanges, a quantity of the second plurality of exchanges being equal to N/2, where N is a length of the input sequence.
